(19) United States
(12) Patent Application Publication
(10) Pub. No.: US 2010/0062728 A1
(43) Pub. Date: Mar. 11, 2010

(54) Tuning an electrically small antenna

(75) Inventors: Greg Black, Vernon Hills, IL (US); Vijay Asrani, Round Lake, IL (US); Rene Alan Christian, Brookfield, WI (US); Prem Ganeshan, Arlington Heights, IL (US)

Correspondence Address: The Watson Intellectual Property Group, PLC;[Motorola], 3133 Highland Drive, Suite 200, Hudsonville, MI, 49426, US

(73) Assignee: Motorola, Inc,

(21) Appl. No.: 12/231,705

(22) Filed: Sep. 5, 2008

(51) Int. Cl. H04B 1/40

(52) U.S. Cl. 455/77

(57) ABSTRACT

An electrically small antenna, such as one physically sized appropriate to a mobile device, can be tuned in response to a detected change that can result in poorer reception using the electrically small antenna. Such detected changes include a detected change in the connectivity of a wired accessory relative to the mobile device, a detected change in a position of the mobile device, and a detected change of an audio channel selected by the mobile device. To minimize any user impact of the retuning of the electrically small antenna, a timer can be initiated and the antenna can be retuned during an opportune time, such as when one or more signal metrics associated with a signal being provided to the user drop below a threshold, or when the timer expires, whichever occurs first.

### FIELD OF THE INVENTION

This invention relates generally to antennas, and more particularly to an antenna tuning mechanism in a communication device.

### BACKGROUND OF THE INVENTION

An antenna's “electrical length” is directly proportional to its physical length and is inversely proportional to the speed of electromagnetic wave propagation through the antenna as compared to the speed of light in a vacuum. Significantly, an antenna's electrical length determines the resonant frequency of the antenna. When used to receive electromagnetic signals, an antenna is most effective at its resonant frequency and whole number multiples of that resonant frequency. Consequently, if possible, antennas are selected such that their electrical length provides for a resonant frequency that is a whole multiple of the frequency of the electromagnetic signals sought to be received by an antenna. For example, an antenna to receive 1900 MHz signals could be designed to be approximately 6 inches in length. If made from a wire of highly conductive material, such as copper, such an antenna would have an electrical length of slightly more than 6 inches, resulting in an resonant frequency very close to 1900 MHz.

Unfortunately, to receive lower frequency electromagnetic signals using such an antenna design would require prohibitively large antennas. Consequently, practical antenna design often focuses on antennas whose electrical length is equal to half of the wavelength of the electromagnetic signal sought to be received, or even a quarter of the wavelength of the electromagnetic signal to be received. And, as will be known by those skilled in the art, quarter-wavelength and half-wavelength antennas can be designed to be effective receptors of the intended electromagnetic signals.

Antennas whose electrical length is significantly smaller than a quarter of the wavelength of the electromagnetic signal sought to be received can be poor receptors of such electromagnetic signals. As a result, such antennas can be referred to as “electrically small” antennas, since their electrical length is insufficient to establish a resonant frequency usefully proximate to the frequency of the electromagnetic signal sought to be received. For purposes of the description below, the term “electrically small” means antennas whose electrical length is no greater than one-eighth of the wavelength of the electromagnetic signal sought to be received. For example, traditional frequency modulated (FM) radio signals deliver audio through frequency modulation, with each radio station transmitting a signal within the 87.5 MHz to 108 MHz frequency band. Such a frequency band encompasses signals whose wavelengths range from approximately 9 feet to slightly larger than 11 feet. Consequently, an antenna that has an electrical length of 13 inches or less is considered to be an “electrically small” antenna, as that term is used herein.

Within the context of portable communication devices, such as the ubiquitous cellular telephone, even a 13 inch antenna would be impractical, as such devices are often designed to fit within a pocket or small purse and, as a result, are rarely more than a few inches long. Consequently, due to the physical limitations of the portable communication devices themselves, any antenna connected to such devices that was to receive FM radio signals, or other similar electromagnetic signals that have a wavelength of longer than three feet, would, as that term is used herein, be considered an “electrically small” antenna.

### SUMMARY OF THE INVENTION

For a mobile communication device to receive FM radio signals, or other electromagnetic signals that have long wavelengths, as compared to the size of the mobile communication device, one or more electrically small antennas associated with the mobile communication device can be tuned to provide improved reception of such electromagnetic signals by the electrically small antenna. In one embodiment, the tuning can be initiated by the detection of one or more of: a change in the connectivity of a wired accessory relative to the mobile device, a change in the position of the mobile device, or a change in the desired frequency of the electromagnetic signals that the mobile device seeks to receive. Once one or more such changes are detected, a retuning of the one or more electrically small antennas can be performed, such as by varying a capacitance connected in series with the electrically small antenna.

Because such tuning can cause an interruption of the receipt of electromagnetic signals, it can be preferable to perform such tuning during a time when the user of the mobile communication device is not likely to notice, or be disturbed, by such tuning. Consequently, in one embodiment, the detection of the above-indicated changes can trigger, not the retuning of the antenna directly, but rather a timer that can establish a time interval during which the antenna can be retuned at an opportune time, if such an opportune time occurs prior to the expiration of the timer. If an opportune time does not occur prior to the expiration of the timer, the retuning can be triggered by the expiration of the timer. In one embodiment, an opportune time to retune the antenna can be any time when the signal metrics associated with the signal being provided to the user of the mobile communication device, such as the audio signal from an FM radio station, drop below a threshold. Such a drop can occur intentionally, such as a broadcast pause between songs, or it can be a result of increasingly poor reception of, for example, the FM radio signal.

In another embodiment, a retuning of the electrically small antenna can be triggered upon detection of a decrease, below a threshold, of the signal metrics associated with the signal being provided to the user of the mobile communication device without reference to a timer and without detecting a change in either the connection of a wired accessory to the mobile communication device, the position of the mobile device or the selected frequency of the electromagnetic signals that the mobile device seeks to receive.

In a further embodiment, at least one of the one or more electrically small antennas associated with the mobile communication device can be a dipole antenna. For mobile communication devices whose enclosure comprises two physically distinct elements, such a dipole antenna can be spread out across both physically distinct enclosure elements to provide maximum coverage.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### BRIEF DESCRIPTION OF THE DRAWINGS

The following detailed description may be best understood when taken in conjunction with the accompanying drawings, of which:

FIG. 1 is a block diagram of an exemplary antenna tuning structure for electrically small antennas;

FIG. 2 is a block diagram of an exemplary subsystem of a mobile communication device comprising a tunable electrically small antenna;

FIG. 3 is a perspective diagram of various exemplary mobile communication devices and associated tunable electrically small antennas;

FIG. 4 is a flow diagram of an exemplary tuning process for an electrically small antenna; and

FIG. 5 is a flow diagram of another exemplary tuning process for an electrically small antenna.

### DETAILED DESCRIPTION

The following description relates to the automatic retuning of an electrically small antenna to provide for greater reception of electromagnetic signals by a mobile communication device. The retuning can be initiated by any one or more of: a change in the connectivity of a wired accessory relative to the mobile device, a change in the position of the mobile device, or a change in the desired frequency of the electromagnetic signals that the mobile device seeks to receive. To minimize the impact, on the user of the mobile communication device, of such a retuning, the retuning can be performed, if practical, during periods when one or more “signal metrics” associated with the signal being consumed by the user is below a threshold. For purposes of the description below, the term “signal metric” means any or all of the signal level of a desired electromagnetic input signal, the signal level of an output signal, such as an audio output signal originally carried by the desired electromagnetic input signal, the signal level of undesired signals or other noise, or a combination thereof, such as a signal-to-noise ratio. Consequently, the relevant threshold may be a predetermined signal level of the desired electromagnetic input signal or the audio output signal, or a predetermined level of an undesired signal or noise, or a combination thereof, such as a predetermined signal to noise ratio. If such a period does not occur within a predetermined amount of time, the expiration of a timer, initiated when one or more of the above changes were detected, can instead trigger the retuning.

The techniques described herein focus on the retuning of one or more electrically small antennas within a mobile communication device within the context of receiving radio signals and presenting, to the user of the mobile communication device, the audio signal carried by the received radio signals. However, the teachings below are equally applicable to the receipt of any type of corresponding electromagnetic signals and are equally applicable to any type of electronic device. Consequently, the descriptions below are not meant to limit the enumerated embodiments to the specific radio tuning mechanisms referenced.

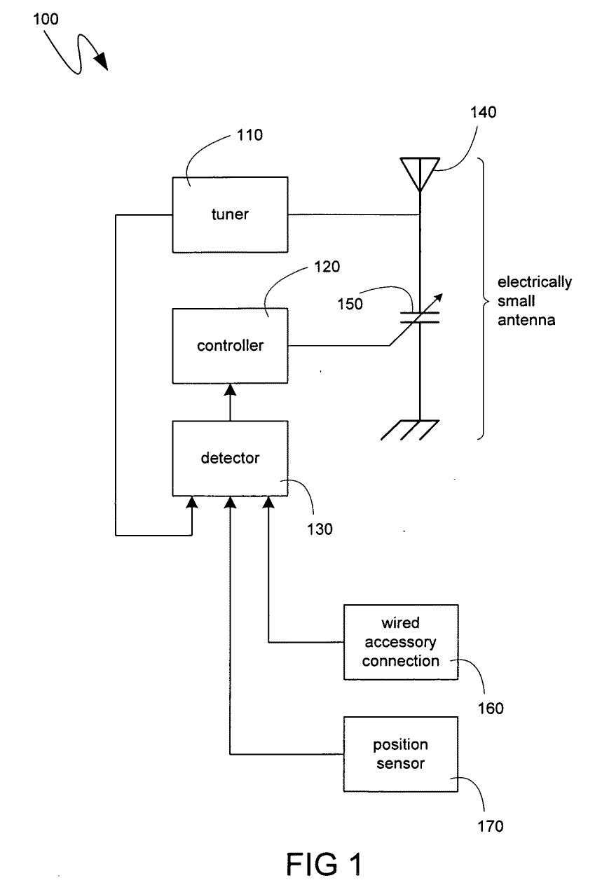

Turning to FIG. 1, an exemplary antenna tuning structure 100 is illustrated comprising an electrically small antenna 140 and a variable capacitance 150 that can be used to tune the electrically small antenna 140. The variable capacitance 150 can be controlled by a controller 120, which can be one or more microcontrollers or can be a dedicated controlling circuit capable of varying the capacitance 150 through the series or parallel connection of one or more physical capacitors. A tuner 110 can be connected to the electrically small antenna 140 to tune in specific ones of the electromagnetic signals being received by the antenna 140. For example, in one embodiment, the tuner 110 can be an Frequency Modulation (FM) radio tuner capable of tuning in the FM radio signals transmitted by one or more FM radio stations broadcasting on predetermined frequencies or frequency bands.

A detector 130 can monitor the output of the tuner 110 to detect the signal strength, quality, or other signal attributes of the signal being output by the tuner. For example, if the tuner 110 is an FM radio tuner, the detector 130 can monitor the audio signal being output by the tuner to detect periods of audio inactivity, such as between songs, or periods of poor reception, such as when the output audio signal decreases in comparison to the output noise. In either such case, where one or more of the signal metrics associated with the output signal have dropped below a threshold, the antenna 140 can be retuned with a minimum of impact on the output. As will be known by those skilled in the art, the retuning of an antenna, such as the antenna 140, can introduce undesirable effects into the signal being output by the tuner 110. For example, retuning the antenna 140 can cause the tuner 110 to momentarily output a burst of white noise or can cause the desirable output of the tuner 110 to become interrupted. In one embodiment, to minimize the undesirable effects of retuning the antenna 140, the detector can monitor the tuner 110 for periods when one or more of signal metrics associated with the output signal of the tuner fall below a threshold and can trigger the controller 120 to tune the antenna when such an event occurs.

The controller 120 can tune the electrically small antenna 140 by adjusting the value of the capacitance 150. In one embodiment, the controller 120 can reference a “lookup table” comprising capacitance values appropriate for the capacitance 150 given a range of other factors. The lookup table can be generated through empirical determinations of which capacitance values, for the capacitance 150, provide for an appropriate antenna 140 resonance. For example, testing the electrically small antenna 140, within the context of the relevant mobile communication device, can reveal that a capacitance of 350 pF can provide maximum reception, by the antenna, of a radio station transmitting at 98 MHz. Similarly, the testing can reveal that a capacitance of 400 pF can provide for maximum reception, by the antenna 140, of a radio station transmitting at 100 MHz. In such a case, the lookup table referenced by the controller 120 can contain this empirically derived data so that, if the detector 130 were to determine that the tuner had changed from tuning in the radio station transmitting at 98 MHz to tuning in the radio station transmitted at 100 MHz, the controller 120 could, by referencing the lookup table, determine that the value of the capacitance 150 should be changed from 350 pF to 400 pF.

In addition to simply relating appropriate values, as empirically determined, of the capacitance 150 to the frequency and/or type of electromagnetic signals being selected by the tuner 110, the lookup tables referenced by the controller 120 can correlate other variables to an empirically determined optimal value of the capacitance 150. For example, the physical connection of a wired accessory to a mobile communication device housing the antenna 140 can itself act as an antenna and can change the reception properties of the antenna 140. One or more other lookup tables can be generated relating optimal capacitance 150 values to the frequency being tuned in by the tuner 110, given the presence of a, or even a specific type of, wired accessory.

Similarly, the position of a mobile communication device housing the antenna 140 can impact the ability of the antenna 140 to receive some electromagnetic signals. Consequently, the lookup tables referenced by the controller 120 can take into account the position of the mobile communication device, such as the relative position of one or more housing elements. For example, one lookup table can correlate optimal capacitance 150 values to the frequency being tuned in by the tuner 110 when the mobile communication device is in a “closed” position, such that one physical portion of the mobile communication device is substantially overlapping a second physical portion. A second lookup table can then correlate optimal capacitance 150 values to the frequency being tuned in by the tuner 110 when the mobile communication device is in a “open” position, such that one physical portion of the mobile communication device is positioned away from a second physical portion. Yet another lookup table can correlate optimal capacitance 150 values to the frequency being tuned in by the tuner 110 when the mobile communication device is physically proximate to a user, or another large object that can impact the reception of electromagnetic signals by the antenna 140.

The detector 130, in addition to monitoring the tuner 110, can also receive information from a wired accessory connection 160 and a position sensor 170, and can, thereby, enable the controller 120 to select an appropriate lookup table. In one embodiment, one or more wired accessory connections, such as the wired accessory connection 160 can be monitored by the detector 130, or can proactively provide information to the detector, to enable the detector to determine if one or more wired accessories are physically connected to the mobile communication device, or are otherwise associated with the mobile communication device such that they may impact the reception of electromagnetic signals by the antenna 140. Examples of such accessories include detachable Radio Frequency (RF) antennas, headsets, speakers, ear-buds, microphones, media players and the like, and detachable housing components such as replaceable housings, shells, or boots, battery doors, and the like. In another embodiment, the mobile communication device can comprise, or can otherwise be associated with, one or more position sensors, such as the position sensor 170, that can provide relevant position information to the detector 130. The position sensor 170 can, for example, detect the physical orientation of the mobile communication device, including, for example, whether the mobile communication device is in an open or closed position. Such a position sensor can comprise physical contacts that can be connected, or disconnected, based on the physical position of one aspect of the mobile communication device with respect to another aspect of the mobile communication device. The position sensor 170 can, also, for example, detect the position of the mobile communication device within a multi-dimensional space such as, for example, whether the mobile communication device is proximate to one or more objects. In such a case, the position sensor can comprise proximity detectors that can operate through various wireless detection mechanisms, such as infrared-based detection mechanisms.

In an alternative embodiment, the controller 120 can adjust the capacitance 140 based on an automatic feedback mechanism often referred to in the art as an “autotuner.” The use, by the controller 120, of an autotuner can be instead of the lookup tables described in detail above, or it can be in addition to such mechanisms. An autotuner, as will be known by those skilled in the art, can comprise a transmitter of electromagnetic signals of the same frequency as those being tuned in by the tuner 110. The autotuner can then transmit a test electromagnetic signal at the relevant frequency and the controller 120 can vary the value of the capacitance 150 across a predetermined range and the detector 120 can monitor the output of the tuner 110. When the optimum reception of the test signal is identified by the detector 130, the corresponding value of the capacitance 150 selected by the controller 120 can be found to be an optimal value. In such a manner, the selected value of the capacitance 150 can be based on then-existing environmental factors and may, in some circumstances, be more accurate.

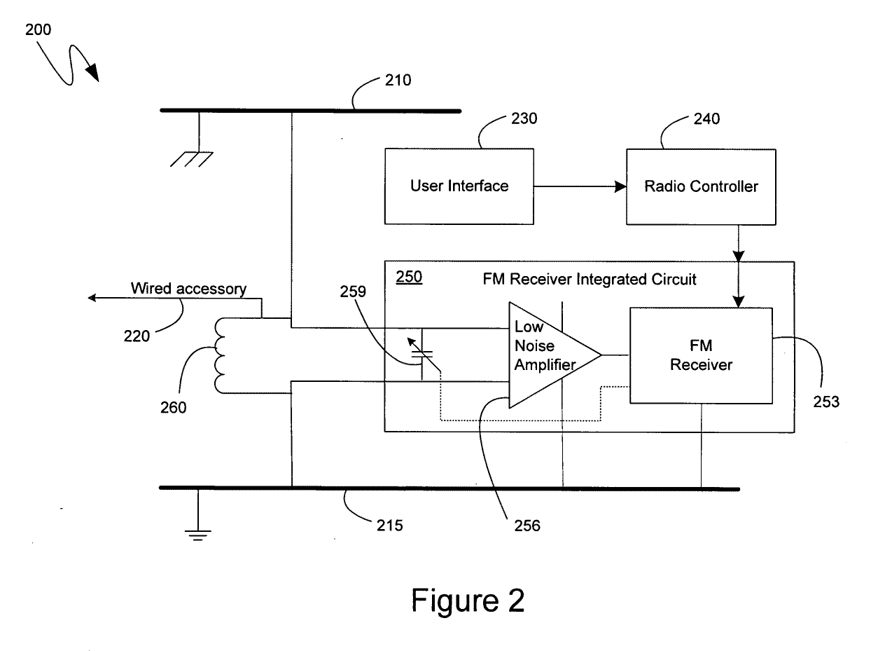

In one embodiment, the electrically small antenna 140 can be physically integrated into, or otherwise physically coupled to, a mobile communication device. In such a case, a dipole antenna can be used to maximize the reception of electromagnetic signals given the physical size constraints of the mobile communication device. Turning to FIG. 2, an exemplary antenna subsystem 200 of a mobile communication device is illustrated, including an electrically small antenna in the form of a dipole antenna comprising antenna elements 210 and 215. As shown, the two dipole antenna elements 210 and 215 can be connected to a receiver, such as the illustrated FM receiver 250, which can be in the form of an integrated circuit to enable efficient utilization of space within the mobile communication device. The antenna circuit can further comprise an inductive element 260 and a capacitance 259, which can be part of the receiver integrated circuit 250 and which can be adjusted to tune the antenna, such as in the manner described above.

The receiver integrated circuit 250 can comprise, in addition to the capacitance 259, an amplifier, such as the low-noise amplifier 256, which can amplify electromagnetic signals received by the dipole antenna elements 210 and 215 and provide such amplified signals to a receiver component, such as the FM receiver 253, which can also be part of the receiver integrated circuit. As part of the mobile communication device, a user interface 230, such as a visual interface or an aural interface, can enable a user of the mobile communication device to select a particular set of electromagnetic signals to be received and their content presented to the user. For example, the user interface 230 can enable the user to select one or more FM radio stations to be received by the mobile communication device, and the audio content of those stations to be presented to the user, such as through a speaker of the mobile communication device, or through a wired or wireless headset. A radio controller 240 can receive the user's selections from the user interface 230 and can direct a receiver, such as the FM receiver integrated circuit 250, to tune-in appropriate ones of the electromagnetic signals received by the dipole antenna elements 210 and 215.

In one embodiment, as indicated by the dashed line correlating the variable capacitance 259 with the FM receiver 253, the FM receiver integrated circuit 250 can comprise relevant elements to implement the antenna tuning described above. For example, the user's selections, as provided by the radio controller 240, can be tuned-in by the FM receiver 253 and the output signal can, as indicated above, be monitored to detect if one or more signal metrics associated with it fall below a threshold value or a threshold quality level. In one embodiment, such a decrease below a threshold can, by itself, trigger a tuning of the antenna via an adjustment of the capacitance 259. In such a case, the FM receiver integrated circuit 250 can itself comprise the relevant elements to detect the decrease, below the threshold, of the one or more signal metrics associated with the signal output by the FM receiver 253, and it can further comprise the relevant elements to adjust the capacitance 259. More generally, the FM receiver integrated circuit 250 can, in one embodiment, comprise at least some of the controller 120 and the detector 130, whose operation was described above in connection with FIG. 1.

As indicated previously, the connection, or disconnection, of a wired accessory can trigger, either directly or indirectly, a retuning of an antenna of the mobile communication device. Thus, as illustrated by exemplary antenna subsystem 200, if the antenna is a dipole antenna, such as comprised by antenna elements 210 and 215, the presence of a wired accessory 220 can enable the wired accessory to act as one of the two elements of the dipole antenna. Consequently, when retuning the antenna due to the connection of a wired accessory, such as wired accessory 220, the retuning can seek to optimize the reception via a dipole antenna comprising the wired accessory instead of, for example, antenna element 210. Similarly, retuning triggered by the disconnection of a wired accessory can result in retuning to optimize the reception via the antenna elements 210 and 215, as opposed, for example, to antenna elements comprising the wired accessory 220.

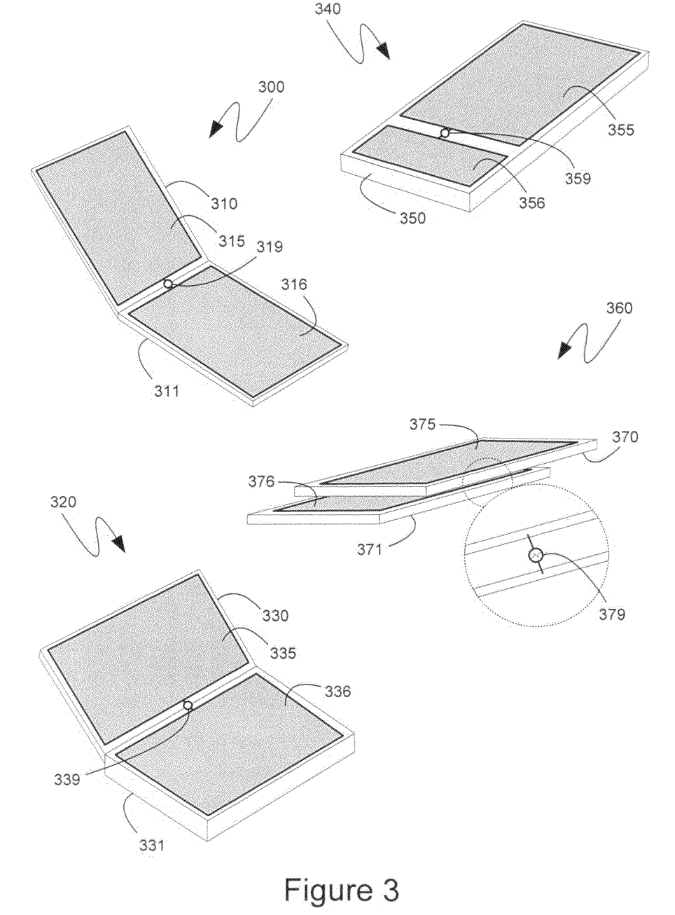

Turning to FIG. 3, exemplary mobile communication devices 300, 320, 340 and 360 are illustrated, showing exemplary positions of a mobile communication device, which can result in potentially multiple orientations of the antenna elements 210 and 215, of FIG. 2. As indicated previously, a dipole antenna arrangement with two elements, such as elements 210 and 215 can enable the largest antenna structures within the physical limitations of the mobile communication devices, and can provide for maximum reception of range of relevant electromagnetic signals.

For example, as shown in FIG. 3, a mobile communication device 300 can be in the form of a standard “flip phone” such that, for example, a top part 310 can comprise a display element (not shown), while a bottom part 311 can comprise data entry elements, such as a keyboard or numeric dial pad (neither shown). Such a mobile communication device 300 can comprise a dipole antenna in the form shown, with a first element 315 integrated with the top part 310, and sized such that it is substantially the same length and width as the top part and/or fits within the space defined thereby, and a second element 316 integrated with the bottom part 311 also sized such that it is substantially the same length and width as the bottom part and/or fits within the space defined thereby. The first antenna element 315 and the second antenna element 316 can be connected via a connector 319, which can comprise the capacitance 259.

In another embodiment, a mobile communication device 320 can be in the form of a standard “alphanumeric pager” such that, for example, a top part 330 can comprise an alphanumeric display element (not shown), while a bottom part 331 can comprise data entry elements, such as a keyboard or a five-position cursor switch (neither shown). As with the flip phone mobile communication device 300, the alphanumeric pager mobile communication device 320 can also comprise a dipole antenna comprising a first element 335 integrated with the top part 330, and a second element 336 integrated with the bottom part 331. The first antenna element 335 and the second antenna element 336 can be connected via a connector 339, which can comprise the capacitance 259.

In the case of a mobile communication device in the form of a “candy bar” phone, such as the mobile communication device 340, the antenna elements 355 and 356 can both be integrated into the single body portion 350 of such a device. In one embodiment, a first antenna element 355 can be sized to encompass and/or fit within a more substantial portion of the area available for an antenna within the body 350, while a second antenna element 356 can be sized to encompass and/or fit within the remaining area. As previously, the antenna elements 355 and 356 can be connected via a connector 359, which can comprise the capacitance 259.

In yet another embodiment, a mobile communication device 360 in the form of a “slider phone” can comprise a top body element 370 that can slide, at least partially, over a bottom body element 371. Traditionally, the top body element 370 can comprise a display element (not shown), while the bottom body element 371 can comprise, on at least a portion of it, a data entry element, such as a keyboard or numeric dial pad (neither shown), that can be exposed when the top body element is slid away from a position in which it completely overlaps the bottom body element. Such a slider phone mobile communication device 360 can comprise a dipole antenna comprising a first element 375 that can be integrated with the top body element 370, and can be sized such that it is formed by and/or fits within the same length and width as the top body element, and a second element 376 that can be integrated with the bottom body element 371 and can be sized such that it is formed by and/or fits within the same length and width as the bottom body element. Additionally, as shown in the side-view enlargement, the first antenna element 375 and the second antenna element 376 can be connected via a connector 379, which can comprise the capacitance 259.

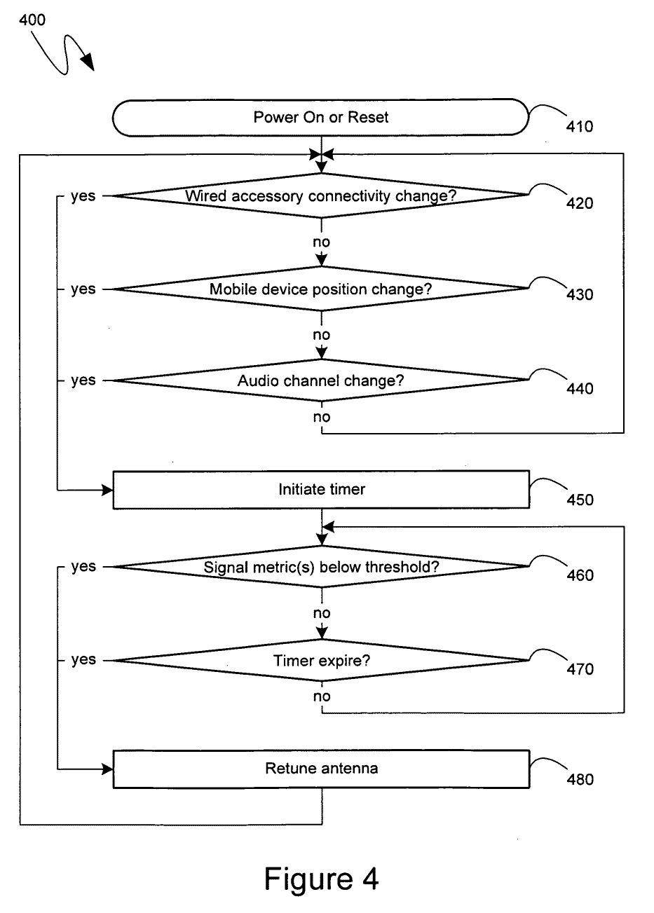

As indicated previously, the electrically small antenna, embodiments of which can be in the form of a dipole antenna, such as those described in detail above, can be tuned, ideally during an audio null, or another time when the retuning of the electrically small antenna may not be disruptive to a user, such as when one or more signal metrics associated with a signal being presented to the user drop below a threshold. Turning to FIG. 4, the flow diagram 400 illustrates an exemplary mechanism by which such tuning of an electrically small antenna can be accomplished. As indicated, processing can commence when the mobile device, such as a mobile communication device is powered on or reset at step 410. Subsequently, as indicated by steps 420, 430 and 440, a series of checks can be made.

As will be recognized by those skilled in the art, the checks of steps 420, 430 and 440 are presented in an arbitrary order and can be performed in any order with respect to one another or can even be performed with varying periodicity.

For the simplicity of illustration and description, however, the checks of steps 420, 430 and 440 are shown and described as being dependent. Thus, at step 420, a check can be made to determine whether there was a change with respect to the connection of a wired accessory to the mobile device. Such a change can encompass the connection or disconnection of a wired accessory, or the connection or disconnection of additional wired accessories. If no such change is detected, processing can proceed to the check at step 430. However, if a change in the connectivity of a wired accessory is detected, processing can skip to step 450, wherein a timer can be initiated. In one embodiment, step 420 can comprise, rather than an explicit action, merely the existence of an appropriate notification mechanism that can provide a notification upon a change of the connectivity of a wired accessory, and an appropriate response mechanism that can implement the initiation of the timer at step 450 if such a change occurs.

At step 430 another check, this one for a change in the position of the mobile device, can be made. As indicated previously, the detected position change can include both changes to the position of one part of the mobile device with respect to another part of the mobile device, and changes to the position of the mobile device with respect to its surroundings. Thus, for example, if the mobile device is a flip phone mobile communication device 300, then the detected position change can include changes to the position of the top part 310 with respect to the bottom part 311. More colloquially, such detected position changes would detect whether the mobile communication device 300 was in an “open” or “closed” position. Additionally, the position change detected at step 430 can comprise a change in the position of the mobile device with respect to its surroundings, such as, for example, whether the mobile device has been brought close to the ear of the user, whereby the user's head and body could impact the reception of electromagnetic signals. As with step 420, the check, at step 430, for a position change need not be an explicit action, and can instead be the existence of an appropriate notification mechanism that can provide a notification upon a relevant change of the mobile device's position, and an appropriate response mechanism that can implement the initiation of the timer at step 450 if such a change occurs.

If, at step 430, it is determined that the position of the mobile device has changed, then a timer can be initiated at step 450. If, however, no such change is detected, an additional check can be performed at step 440 to determine if the particular electromagnetic signal that was being tuned in by the mobile device has changed. For example, step 440 can detect a change in the FM radio broadcast being listened to by a user of the mobile device. Alternatively, step 440 can detect a change from, for example, an FM radio broadcast to a weatherband broadcast, or an Amplitude Modulation (AM) radio broadcast. If such a change is detected, the timer of step 450 can be initiated. If no such change is detected, the checks of steps 420, 430 and 440 can be repeated until one or more of them detect a change. As before, the check for an audio channel change, at step 440, need not be an explicit action, and can instead be the existence of an appropriate notification mechanism that can provide a notification upon a change in the audio channel selected by the user, and an appropriate response mechanism that can implement the initiation of the timer at step 450 if such a change occurs.

The initiation of the timer, at step 450, can provide a mechanism by which the electrically small antenna, being used by the mobile device to receive the content that the user is consuming, such as FM radio signals, can be retuned in a manner that minimizes the impact of such a retuning on the user. Specifically, the timer is initiated, at step 450, because one or more of the changes detected at step 420, 430 or 440 is such that it could result in a change in the ability of the electrically small antenna to maximally receive the desired electromagnetic signals. However, if the reception remains of a sufficient quality, then an immediate retuning, upon the detection of a change at steps 420, 430 or 440, could negatively impact the user's listening experience. Consequently, the initiation of a timer, establishes, at step 450, an upper time limit by which a retuning will, in one embodiment, be performed. To minimize the impact on the user, however, a check can be made, at step 460, to determine if one or more signal metrics associated with the signal being presented to the user has dropped below a threshold. If it has, then a retuning can be accomplished with minimal user impact and can be performed at that time. If it has not, however, then the signal being presented to the user can be monitored until either one or more signal metrics associated with it drop below the threshold or until the timer expires, thereby providing the retuning that can have been necessitated by the change detected by steps 420, 430 or 440 with a minimum of user impact.

As shown in FIG. 4, therefore, upon initiation of the timer at step 450, a check can be made, at step 460, to determine if one or more signal metrics associated with the signal being presented to the user has fallen below a threshold. In one embodiment, as indicated previously, the check at step 460 can monitor the quality of the signal being presented to the user. Thus, for example, if the signal-to-noise ratio falls below a threshold, or a received audio signal is being drowned out by static, a determination can be made, at step 460, that at least one signal metric associated with the signal being presented to the user has fallen below a threshold. In another embodiment, the check at step 460 can monitor the overall magnitude of the signal to detect a break, during which there may not be any meaningful signal being provided to the user. For example, an “audio null” can be utilized by radio stations to aurally separate two different songs. Such an audio null can result in no musical data being presented to the user, and can, therefore, be an opportune time to tune the electrically small antenna receiving the electromagnetic signal that is carrying the audio signal. Consequently, such an audio null, or other break, can likewise be a signal metric associated with the signal being presented to the user that can be detected at step 460.

If step 460 detects an opportune time to perform a retuning of the electrically small antenna with a minimum of user impact, it can trigger a retuning of the antenna at step 480. If none of the signal metrics associated with the signal being presented to the user drop below a relevant threshold, as detected at step 460, then step 460 can continue to monitor the signal, such as by looping back to itself, while the timer initiated at step 450 remains unexpired. In one embodiment such a loop can be implemented by first checking, at step 470, if the timer has expired, and then looping back to step 460 if it has not. If the timer has expired, as determined by step 470, the retuning of the antenna at step 480 can be triggered.

As with the checks at step 420, 430 and 440, the checks at step 460 and 470 are illustrated and described as dependent linear events for ease of illustration and description. In other embodiments, the check of the signal metrics associated with the signal being provided to the user at step 460 can be implemented through a continuous monitoring process and the timer expiration of step 470 can be implemented through an independent triggering mechanism, such that an equivalent result is obtained.

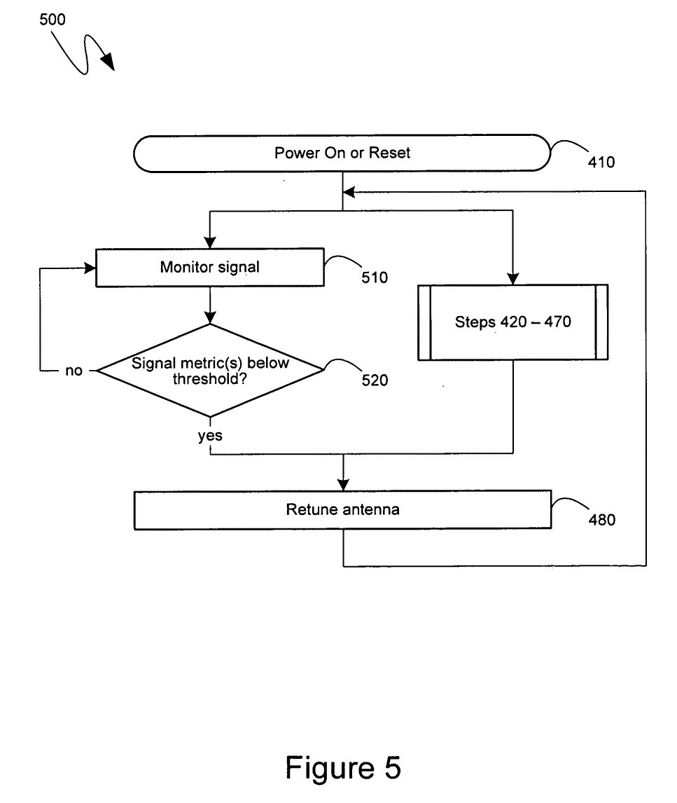

In another embodiment, if one or more signal metrics associated with the signal being provided to the user drop below a threshold, which can either be equivalent thresholds to those referenced previously, or a different set of thresholds, a retuning can be performed irrespective of whether a change was detected in the position of the mobile device, the connectivity of a wired accessory, or the channel which the user had previously selected. Turning to FIG. 5, an alternative flow diagram 500 illustrates such an embodiment. Specifically, in parallel to steps 420 through 470, described above, a monitoring process 510 can monitor the signal being presented to the user at step 510. If, at step 520, one or more signal metrics associated with such a signal are found to be below a threshold, the retuning of step 480 can be performed even if neither of the steps 420, 430 or 440 resulted in the triggering of a timer at step 450. As before, the check, at step 520 can monitor, among other signal metrics, either or both the signal strength with respect to noise and the signal strength with respect to whether any meaningful signal is being provided at all, such as during a break when no meaningful signal may be provided.

In such a manner, the retuning of the electrically small antenna can be performed at opportune times, when such a retuning can minimize the impact on the user consuming the signals being carried by the electromagnetic signals being received by the electrically small antenna, even if there may not have been any specifically detected event that should, theoretically, have required such a retuning.

As can be seen from the above descriptions, mechanisms for retuning electrically small antennas at opportune times have been presented. In view of the many possible variations of the subject matter described herein, we claim as our invention all such embodiments as may come within the scope of the following claims and equivalents thereto.

We claim:

1. A method of tuning an electrically small antenna associated with a mobile device, the method comprising the steps of:
detecting a change in at least one of: a connectivity of a wired accessory relative to the mobile device, a position of the mobile device, and an audio channel selected by the mobile device;
initiating a timer upon the detecting the change; and
retuning the electrically small antenna upon an earlier of an expiration of the timer and a detection of at least one signal metric, associated with an audio signal from the audio channel selected by the mobile device, dropping below a threshold.

2. The method of claim 1, wherein the electrically small antenna is a dipole antenna formed by two parts of a chassis of the mobile device.

3. The method of claim 2, wherein the detecting the change in the position of the mobile device comprises detecting a change in a position of a first of the two parts of the chassis of the mobile device with respect to a second of the two parts of the chassis of the mobile device.

4. The method of claim 1, wherein the detecting the change in the position of the mobile device comprises detecting a change in a position of the mobile device with respect to a user of the mobile device.

5. The method of claim 1, wherein the retuning is performed with reference to lookup tables.

6. The method of claim 1, wherein the retuning is performed via an autotuner.

7. The method of claim 1 further comprising the step of retuning the electrically small antenna, irrespective of the timer, if the at least one signal metric associated with the audio signal drops below the threshold.

8. The method of claim 1, wherein the electrically small antenna is an FM radio antenna internal to the mobile device; and wherein further the mobile device is a cellular telephone.

9. An antenna tuning circuit in a mobile device comprising an electrically small antenna tuned by the antenna tuning circuit, the antenna tuning circuit comprising:
one or more position sensors detecting a position of the mobile device;
one or more wired accessory sensors detecting a connectivity of a wired accessory relative to the mobile device;
a timer;
a timer initiating circuit that initiates the timer when at least one of: the one or more position sensors detects a change in the position of the mobile device, the one or more wired accessory sensors detect a change in the connectivity of the wired accessory relative to the mobile device, and a change in an audio channel selected by the mobile device occurs;
a signal sensor monitoring an audio signal produced by the audio channel selected by the mobile device;
a tuner; and
a tuner activation circuit that activates the tuner to retune the electrically small antenna upon an earlier of an expiration of the timer and a detection, by the signal sensor, of at least one signal metric, associated with the audio signal, dropping below a threshold.

10. The antenna tuning circuit of claim 9, wherein the electrically small antenna is a dipole antenna formed by two parts of a chassis of the mobile device.

11. The antenna tuning circuit of claim 10, wherein the one or more position sensors detect a position of a first of the two parts of the chassis of the mobile device with respect to a second of the two parts of the chassis of the mobile device.

12. The antenna tuning circuit of claim 9, wherein the one or more position sensors detect the position of the mobile device with respect to a user of the mobile device.

13. The antenna tuning circuit of claim 9, wherein the tuner comprises lookup tables used to retune the electrically small antenna.

14. The antenna tuning circuit of claim 9, wherein the tuner comprises an autotuner.

15. The antenna tuning circuit of claim 9, wherein the tuner activation circuit activates the tuner to retune the electrically small antenna, irrespective of the timer, if the at least one signal metric associated with the audio signal drops below the threshold.

16. The antenna tuning circuit of claim 9, wherein the electrically small antenna is an FM radio antenna internal to the mobile device; and wherein further the mobile device is a cellular telephone.

17. A processor for controlling a retuning of an electrically small antenna that is associated with a mobile device, the processor configured to:
receive an indication of a change in at least one of: a connectivity of a wired accessory relative to the mobile device, a position of the mobile device, and an audio channel selected by the mobile device;
initiate a timer in response to the received indication; and
request a retuning of the electrically small antenna upon an earlier of an expiration of the timer and a detection of at least one signal metric, associated with an audio signal from the audio channel selected by the mobile device, dropping below a threshold.

18. The processor of claim 17, wherein the electrically small antenna is a dipole antenna formed by two parts of a chassis of the mobile device.

19. The processor of claim 17, wherein the received indication of the change in the position of the mobile device comprises a received indication of a change in a position of the mobile device with respect to a user of the mobile device.

20. The processor of claim 17 further configured to request the retuning the electrically small antenna, irrespective of the timer, if the at least one signal metric associated with the audio signal drops below the threshold.
